(19) United States
(12) Patent Application Publication
(10) Pub. No.: US 2009/0276346 A1
(43) Pub. Date: Nov. 5, 2009

(54) SYSTEM AND METHOD FOR CLASSIFYING A FINANCIAL TRANSACTION AS A RECURRING FINANCIAL TRANSACTION

(75) Inventors: Marko Rukonic, San Jose, CA (US); George A. Hansen, Danville, CA (US); Benjamin R. Weiss, Portola Valley, CA (US); Jim Del Favero, Redwood City, CA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 12/114,383

(22) Filed: May 2, 2008

(51) Int. Cl. G06Q 40/00

(52) U.S. Cl. 705/35

(57) ABSTRACT

A system that automatically classifies a financial transaction as a recurring financial transaction based on classification data obtained from a set of users is presented. The system can also determine the frequency at which the recurring financial transaction repeats. If the financial transaction is classified as a recurring financial transaction, the system can mark the financial transaction as a recurring financial transaction. Alternatively, the system can notify the user that the classification data indicates that the financial transaction can be classified as a recurring financial transaction.

### BACKGROUND

### Related Art

The present invention relates to financial applications for computer systems.

Some financial applications allow a user to specify whether a given transaction is recurring or not. For example, a utility bill is typically paid every month and can be classified as a “recurring financial transaction.” Although users can specify whether a given financial transaction is recurring or not on a per transaction basis (e.g., by manually flagging a financial transactions as a recurring financial transaction), users typically want a financial application to be configured with as little manual effort as possible. Furthermore, unsophisticated users may not understand how to specify that a given financial transaction is a recurring financial transaction.

### SUMMARY

Some embodiments of the present invention provide a system that automatically classifies a financial transaction as a recurring financial transaction based on classification data obtained from a set of users. The system can also determine the frequency at which the recurring financial transaction repeats. If the financial transaction is classified as a recurring financial transaction, the system can mark the financial transaction as a recurring financial transaction. Alternatively, the system can notify the user that the classification data indicates that the financial transaction can be classified as a recurring financial transaction.

Some embodiments of the present invention provide a system and a method that aggregates classification data which can be used to classify financial transactions as recurring financial transactions. This classification data can then be distributed to one or more clients.

### BRIEF DESCRIPTION OF THE FIGURES

FIG. 1 presents a block diagram illustrating a network in accordance with embodiments of the present invention.

FIG. 2A presents a block diagram illustrating a server in accordance with embodiments of the present invention.

FIG. 2B presents a block diagram of a financial transaction classification module in accordance with embodiments of the present invention.

FIG. 3A presents a block diagram illustrating a client computer system in accordance with embodiments of the present invention.

FIG. 3B presents a block diagram of a recurring financial transaction module in accordance with embodiments of the present invention.

FIG. 4 presents a flow chart illustrating a process for classifying a financial transaction as a recurring financial transaction in accordance with embodiments of the present invention.

FIG. 5 presents a flow chart illustrating a process for distributing aggregated classification data for financial transactions in accordance with embodiments of the present invention.

FIG. 6 presents a flow chart illustrating a process for aggregating classification data for financial transactions in accordance with embodiments of the present invention.

FIG. 7 presents a flow chart illustrating a process for determining the number of financial transactions that are recurring and the number of financial transactions that are not recurring in accordance with embodiments of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description can be embodied as code, data structures, and/or data, which can be stored on a computer-readable storage medium as described above. When a computer system reads and executes the code and/or data stored on the computer-readable storage medium, the computer system performs the methods and processes embodied as code, data structures, and/or data that are stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Network

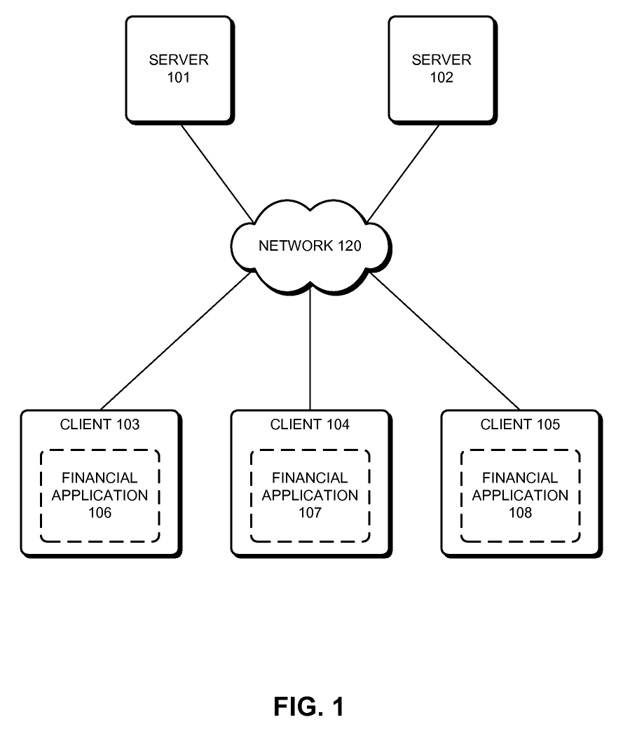

FIG. 1 presents a block diagram illustrating a network 120 in accordance with embodiments of the present invention. In FIG. 1, servers 101-102 and clients 103-105 are coupled to each other through network 120. Note that the number of servers and the number of clients can be more or fewer than what is illustrated in FIG. 1. Network 120 can generally include any type of wired or wireless communication channel capable of coupling together computing nodes. This includes, but is not limited to, a local area network, a wide area network, or a combination of networks. In one embodiment of the present invention, network 120 includes the Internet.

Clients 103-105 can include financial applications 106-108, respectively. Any one of the financial application 106-108 can include, but is not limited to, a personal financial application or a business financial application. Note that financial applications 106-108 can be the same financial application or different financial applications. Also note that clients 103-105 can also include other applications.

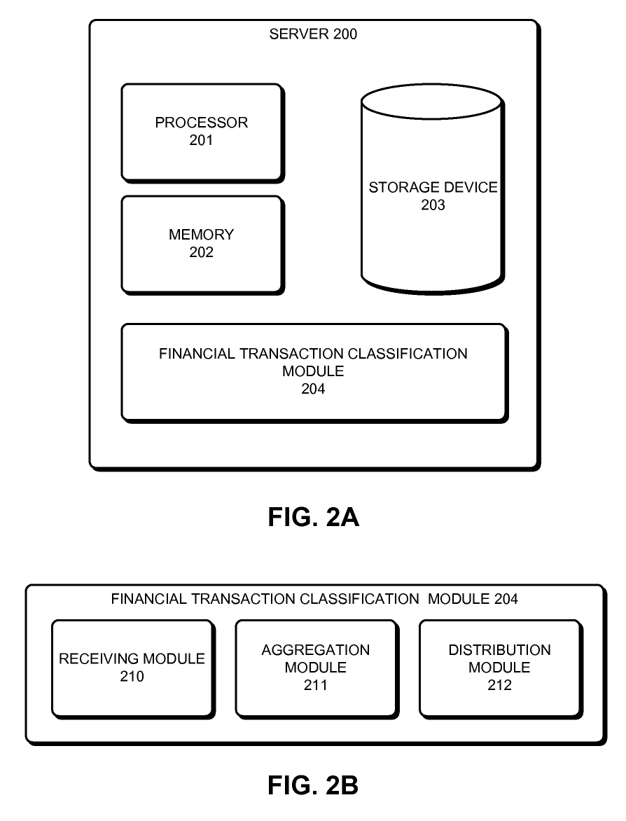

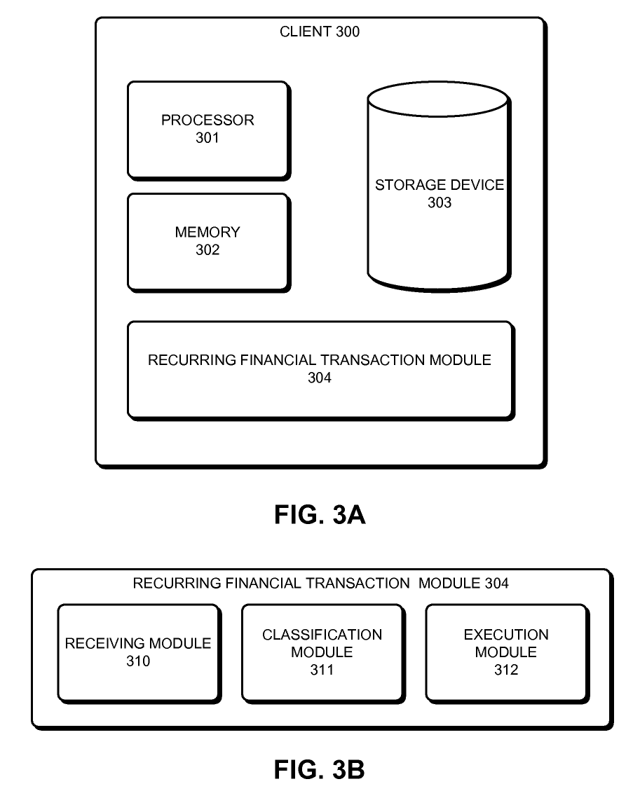

Servers 101-102 are described in more detail with reference to FIGS. 2A-2B below. Clients 103-105 are described in more detail with reference to FIGS. 3A-3B below.

### Server

FIG. 2A presents a block diagram illustrating a server 200 in accordance with an embodiment of the present invention. Note that server 200 can be any one of the servers 101-102 illustrated in FIG. 1. As illustrated in FIG. 2A, server 200 includes one or more of processor 201, memory 202, storage device 203, and financial transaction classification module 204.

Processor 201 can generally include any type of processor, including, but not limited to, a microprocessor, a mainframe computer, a digital signal processor, a personal organizer, a device controller and a computational engine within an appliance. Memory 202 can include any type of memory, including but not limited to, dynamic random access memory (DRAM), static random access memory (SRAM), flash memory, read only memory (ROM), and any other type of memory now known or later developed. Storage device 203 can include any type of non-volatile storage device that can be coupled to a computer system. This includes, but is not limited to, magnetic, optical, and magneto-optical storage devices, as well as storage devices based on flash memory and/or battery-backed up memory.

In some embodiments of the present invention, financial transaction classification module 204 is separate from server 200. Note that financial transaction classification module 204 is described in more detail below with reference to FIG. 2B.

FIG. 2B presents a block diagram of financial transaction classification module 204 in accordance with an embodiment of the present invention. Financial transaction classification module 204 includes receiving module 210, aggregation module 211, and distribution module 212. Receiving module 210 can be configured to receive classification data for financial transactions from a set of users. For example, the set of users can include all users of a specified financial application (e.g., financial applications 106-108). Aggregation module 211 can be configured to aggregate the classification data for the financial transactions. Distribution module 212 can be configured to distribute the aggregated classification data to users so that the users can classify financial transactions using the aggregated classification data. For example, distribution module 212 can distribute the aggregated classification data to a financial application for a user (e.g., any one of the financial applications 106-108 on clients 103-105).

In some embodiments, aggregation module 211 can be configured to group financial transactions that meet specified criteria into a group of financial transactions and to determine the number of financial transactions that are recurring and that are not recurring. While determining the number of financial transactions that are recurring and that are not recurring, aggregation module 211 can be configured to: (1) identify a first set of financial transactions within the group that are not recurring financial transactions; (2) note the number of financial transactions that do not recur; (3) determine a second set of financial transactions within the group that are recurring financial transactions; (4) determine the frequency at which each financial transaction within the set recurs; and (5) note the number of financial transactions that recur at the determined frequencies.

In some embodiments, one or more of receiving module 210, aggregation module 211, and distribution module 212 are included in one or more integrated circuit (IC) chips. For example, these IC chips can include, but are not limited to, application-specific integrated circuit (ASIC) chips, field-programmable gate arrays (FPGAs), and other programmable-logic devices now known or later developed.

### Client Computer System

FIG. 3A presents a block diagram illustrating a client computer system 300 in accordance with an embodiment of the present invention. Note that client computer system 300 can be any one of the clients 103-105 in FIG. 1. Client computer system 300 includes one or more of processor 301, memory 302, storage device 303, and recurring financial transaction module 304.

Processor 301 can generally include any type of processor, including, but not limited to, a microprocessor, a mainframe computer, a digital signal processor, a personal organizer, a device controller and a computational engine within an appliance. Memory 302 can include any type of memory, including but not limited to, dynamic random access memory (DRAM), static random access memory (SRAM), flash memory, read only memory (ROM), and any other type of memory now known or later developed. Storage device 303 can include any type of non-volatile storage device that can be coupled to a computer system. This includes, but is not limited to, magnetic, optical, and magneto-optical storage devices, as well as storage devices based on flash memory and/or battery-backed up memory.

In some embodiments of the present invention, recurring financial transaction module 304 is separate from client computer system 300. In some embodiments, recurring financial transaction module 304 is included in a financial application (e.g., financial applications 106-108). Note that recurring financial transaction module 304 is described in more detail below with reference to FIG. 3B.

FIG. 3B presents a block diagram of recurring financial transaction module 304 in accordance with an embodiment of the present invention. Recurring financial transaction module 304 includes receiving module 310, classification module 311, and execution module 312. Receiving module 310 can be configured to receive a financial transaction from a user. Classification module 311 can be configured to determine whether the financial transaction can be classified as a recurring financial transaction from classification data obtained from a specified set of users. If the financial transaction can be classified as a recurring financial transaction, classification module 311 can be configured to determine a frequency at which the financial transaction is repeated and to classify the financial transaction as a recurring financial transaction that is repeated at the specified frequency. Furthermore, if the financial transaction can be classified as a recurring financial transaction, execution module 312 can be configured to perform one or more specified actions. Note that the one or more specified actions are described in more detail below.

In some embodiments, one or more of receiving module 310, classification module 311, and execution module 312 are included in one or more integrated circuit (IC) chips. For example, these IC chips can include, but are not limited to, application-specific integrated circuit (ASIC) chips, field-programmable gate arrays (FPGAs), and other programmable-logic devices now known or later developed.

### Data Structures

Some embodiments of the present invention provide a classification database which can track financial transactions which have been classified as recurring financial transactions by users of financial applications. In some embodiments, the classification database on a client computer system can include a user-classification table. In some embodiments, the classification database on the server can include a community-classification table. In other embodiments, the server includes both the user-classification table and the community-classification tables. The user-classification table can track a classification (e.g., recurring financial transaction, type of transaction, etc.) of an object (e.g., a payee, a payer, etc.) made by a given user. The community-classification table can track the number of times (e.g., votes) that users of a financial application have classified an object by using a specified classification.

The following example illustrates the use of the user-classification table and the community-classification table. User A can associate an object “car” with the classification “transportation” using a financial application. User A can then make this classification information available to an aggregation system (e.g., any one of servers 101-102). Tables 1 and 2 present the state of the user-classification and community-classification tables, respectively, after the classification data from user A is received.

TABLE 1
User-Classification Table

| User | Object | Classification |
|---|---|---|
| A | Car | Transportation |

TABLE 2
Community-Classification Table

| Object | Classification | Votes |
|---|---|---|
| Car | Transportation | 1 |

If Users B and C query the aggregation system to determine how to classify the object “car”, the aggregation system responds with the classification “transportation”. However, users B and C can override this classification and can specify a new classification of the object “car”. For example, users B and C may associate the object “car” with the classification “investment” and share this classification data with the aggregation system. Tables 3 and 4 present the state of the user-classification and community-classification tables, respectively, after the classification data from users B and C is received.

TABLE 3
User-Classification Table

| User | Object | Classification |
|---|---|---|
| A | Car | Transportation |
| B | Car | Investment |
| C | Car | Investment |

TABLE 4
Community-Classification Table

| Object | Classification | Votes |
|---|---|---|
| Car | Transportation | 1 |
| Car | Investment | 2 |

Thus, the aggregation system knows that user A associates the object “car” with the classification “transportation”, whereas users B and C associate the object “car” with the classification “investment”. In some embodiments, when a user enters another instance of an object already classified by the user into a financial application, the financial application first queries the user-classification table to determine how the user classified the object. In some embodiments, if the classification information for the user is not available in the user-classification table, the financial application queries the community-classification table to determine how other users have classified the object. In making the determination, the financial application can analyze the number of votes for each type of classification for the object. In some embodiments, a majority voting system or a plurality voting system is used. For example, if user D queries the aggregation system to determine how to classify the object “car”, the aggregation system responds by returning the classification “investment”, which is the classification with the most number of votes.

### Recurring Transactions

Users of financial applications typically desire the financial transaction to suggest to the users which of their financial transactions may be recurring and with what frequency. The following example illustrates how a financial application can do so using classification data from an aggregation system.

User A can classify the payee “Power Company A” as a recurring financial transaction with a frequency of one month. Tables 5 and 6 present the state of the user-classification and community-classification tables, respectively, after the classification data from user A is received.

TABLE 5
User-Classification Table

| User | Transaction Description | Frequency |
|---|---|---|
| A | Power Company A | Monthly |

TABLE 6
Community-Classification Table

| Transaction Description | Frequency | Votes |
|---|---|---|
| Power Company A | Monthly | 1 |

User B can then classify the payee Power Company A as a recurring financial transaction with a frequency of one month. Tables 7 and 8 present the state of the user-classification and community-classification tables, respectively, after the classification data from user B is received.

TABLE 7
User-Classification Table

| User | Transaction Description | Frequency |
|---|---|---|
| A | Power Company A | Monthly |
| B | Power Company A | Monthly |

TABLE 8
Community-Classification Table

| Transaction Description | Frequency | Votes |
|---|---|---|
| Power Company A | Monthly | 2 |

User C can then query the aggregation system to determine whether the payee Power Company A is a recurring financial transaction or not. Since the user-classification table does not include information about how user C classified the payee Power Company A, the community-classification table is queried. Since there are two votes for Power Company A being a recurring financial transaction with a monthly frequency, this information is returned to user C.

User D can also retrieve the same information as user C. Thus, the aggregation system indicates that the payee Power Company A is a recurring financial transaction with a monthly frequency. However, user D then decides to change the recurrence of the payee Power Company A to weekly recurrence instead of monthly recurrence. Tables 9 and 10 present the state of the user-classification and community-classification tables, respectively, after the classification data from user D is received.

TABLE 9
User-Classification Table

| User | Transaction Description | Frequency |
|---|---|---|
| A | Power Company A | Monthly |
| B | Power Company A | Monthly |
| D | Power Company A | Weekly |

TABLE 10
Community-Classification Table

| Transaction Description | Frequency | Votes |
|---|---|---|
| Power Company A | Monthly | 2 |
| Power Company A | Weekly | 1 |

User E can also retrieve the same information as users C and D. Since the payee Power Company A has two votes for a monthly frequency and one vote for a weekly frequency, the aggregation system can indicate that the payee Power Company A is a recurring financial transaction with a monthly frequency. However, suppose user E then decides to change the frequency from monthly to “none”. Tables 11 and 12 present the state of the user-classification and community-classification tables, respectively, after the classification data from user E is received.

TABLE 11
User-Classification Table

| User | Transaction Description | Frequency |
|---|---|---|
| A | Power Company A | Monthly |
| B | Power Company A | Monthly |
| D | Power Company A | Weekly |
| L | Power Company A | None |

TABLE 12
Community-Classification Table

| Transaction Description | Frequency | Votes |
|---|---|---|
| Power Company A | Monthly | 2 |
| Power Company A | Weekly | 1 |
| Power Company A | None | 1 |

In some embodiments, the decision as to whether a financial transaction is automatically converted into a recurring financial transaction within a financial application can be based on the actions of other users. For example, if the number of users who have specified a given financial transaction (e.g., a utility bill payment) as a recurring financial transaction exceeds a specified threshold, the financial transaction can be automatically converted into a recurring financial transaction. If the threshold is not exceeded, then the user can be prompted to decide whether the financial transaction is recurring or not. In either case, a user can override the automatic classification and/or conversion of a financial transaction into a recurring financial transaction by changing a preference in the financial application.

### Classifying Financial Transactions

The discussion below generally refers to “a system,” which can include, but is not limited to, a computer system, a server, a client computer system, a cluster of computer systems, a PDA, a mobile device, a component within a plurality of components, and a module within a software application.

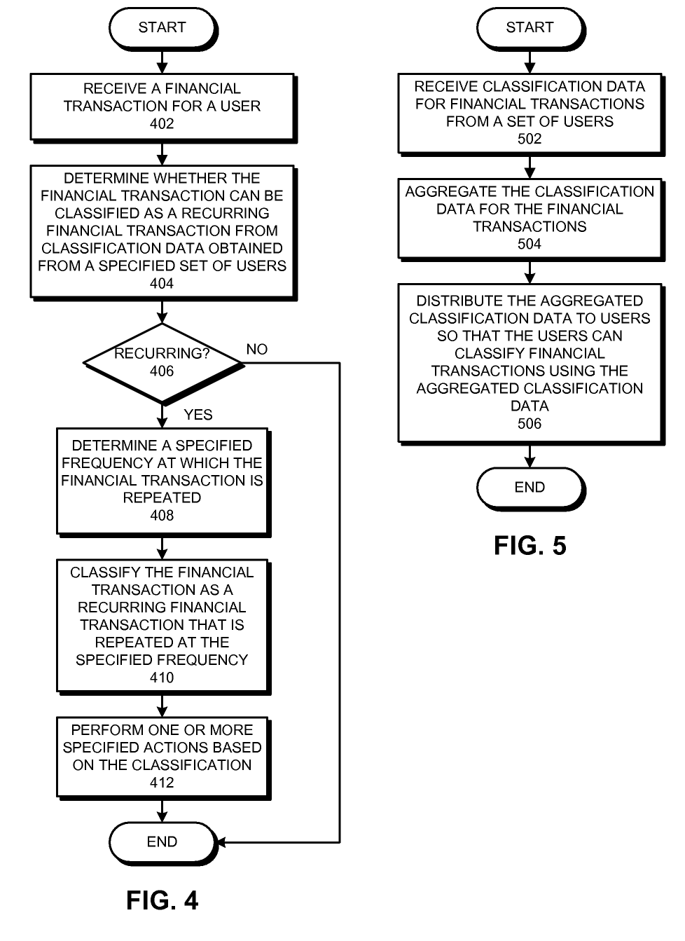

FIG. 4 presents a flow chart illustrating a process for classifying a financial transaction as a recurring financial transaction in accordance with embodiments of the present invention. During operation, the system receives a financial transaction for a user (step 402). Next, the system determines whether the financial transaction can be classified as a recurring financial transaction from classification data obtained from a specified set of users (step 404). In some embodiments, while determining whether the financial transaction is a recurring financial transaction, the system uses one of: a majority voting system; and a plurality voting system.

If the financial transaction can be classified as a recurring financial transaction (step 406 yes), the system determines a specified frequency at which the financial transaction is repeated (step 408). In some embodiments, while determining the specified frequency at which the financial transaction is repeated, the system analyzes the classification data corresponding to the financial transaction which is obtained from the specified set of users. The system then determines the specified frequency at which the financial transaction is repeated from the classification data by applying a majority voting system or a plurality voting system.

Next, the system classifies the financial transaction as a recurring financial transaction that is repeated at the specified frequency (step 410). In some embodiments, after classifying the financial transaction, the system records the financial transaction as a recurring financial transaction. In some embodiments, after classifying the financial transaction, the system suggests that the financial transaction be recorded as a recurring financial transaction.

The system then performs one or more specified actions based on the classification (step 412). In some embodiments, the one or more specified actions can include: (1) reminding the user that the recurring transaction will occur within a specified time period of the next occurrence of the recurring financial transaction; (2) automatically performing the recurring financial transaction at the next occurrence of the recurring financial transaction; (3) automatically entering a record for the recurring financial transaction at the next occurrence of the recurring financial transaction; (4) suggesting that the user perform a specified alternative financial transaction instead of performing the recurring financial transaction; and (5) suggesting that the user perform additional financial transactions based on the classification data obtained from the specified set of users.

In some embodiments, the classification data includes one or more of: the names of payees for financial transactions; the names of payers for the financial transactions; the frequency at which financial transactions are repeated; and the number of users within the specified set of users that has classified the financial transaction as repeating with a given frequency.

In some embodiments, the specified set of users are users which are located within a specified distance of the user.

### Aggregating Financial Transaction Classification Data

FIG. 5 presents a flow chart illustrating a process for distributing aggregated classification data for financial transactions in accordance with embodiments of the present invention. During operation, the system receives classification data for financial transactions from a set of users (step 502). Next, the system aggregates the classification data for the financial transactions (step 504). The system then distributes the aggregated classification data to users so that the users can classify financial transactions using the aggregated classification data (step 506).

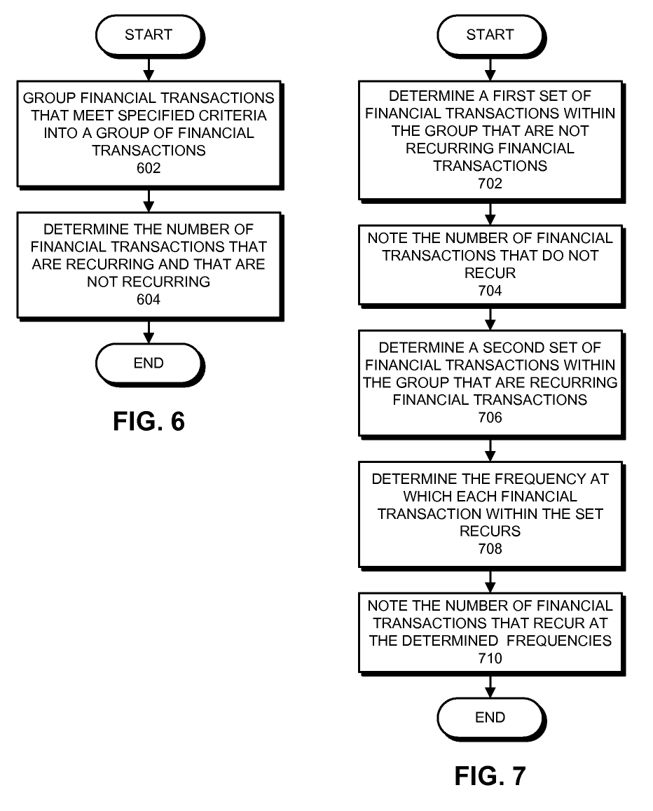

FIG. 6 presents a flow chart illustrating a process for aggregating classification data for financial transactions in accordance with embodiments of the present invention. During operation, the system groups financial transactions that meet specified criteria into a group of financial transactions (step 602). In some embodiments, the specified criteria include: the financial transactions that have the same payer; or the financial transactions that have the same payee. The system then determines the number of financial transactions that are recurring and that are not recurring (step 604).

FIG. 7 presents a flow chart illustrating a process for determining the number of financial transactions that are recurring and that are not recurring in accordance with embodiments of the present invention. During operation, the system determines a first set of financial transactions within the group that are not recurring financial transactions (step 702). Next, the system notes the number of financial transactions that do not recur (step 704). The system then determines a second set of financial transactions within the group that are recurring financial transactions (step 706). Next, the system determines the frequency at which each financial transaction within the set recurs (step 708). The system then notes the number of financial transactions that recur at the determined frequencies (step 710).

In some embodiments, the aggregated classification data can be used to suggest to a user of a financial application that the user has not performed a recurring financial transaction that a specified set of users has performed. For example, consider a user who has just moved to a new area. Users in the new area may all receive power from power company A with a specified frequency (e.g., monthly). Since the user is new to the area, the user has not paid power company A yet (and therefore has no transactions of this type). However, the financial application can use the aggregated classification data to suggest and/or to remind the user to pay power company A.

In some embodiments, the aggregated classification data can be used to suggest to a user of a financial application that the user should use a specified company for a specified service. For example, the user may use cable company A for cable television service. However, the aggregated classification data can include information about that users within a specified distance of the user are using cable company B for cable television service and that the average monthly bill for these users is lower than the user's monthly bill. The financial application can then suggest that the user switch cable television service from cable company A to cable company B.

In some embodiments, the financial application can be executed on one or more of: a client computer system (e.g., as a client application) and a server computer system (e.g., as a web-based application).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A computer-implemented method, comprising:
electronically receiving a financial transaction for a user;
electronically determining whether the financial transaction can be classified as a recurring financial transaction from classification data obtained from a specified set of users;
if so,
electronically analyzing the classification data to determine a frequency at which the financial transaction is repeated, by analyzing a number of votes that the classification data classifies the financial transaction using a specified frequency, and determining a specified frequency which has a plurality of votes;
electronically classifying the financial transaction as a recurring financial transaction that is repeated at the determined frequency; and
electronically performing one or more specified actions based on the classification.

2. The computer-implemented method of claim 1, wherein after classifying the financial transaction, the method further comprises electronically recording the financial transaction as a recurring financial transaction.

3. The computer-implemented method of claim 1, wherein after classifying the financial transaction, the method further comprises electronically suggesting that the financial transaction be recorded as a recurring financial transaction.

4. The computer-implemented method of claim 1, wherein the one or more specified actions include one or more of:
electronically reminding the user that the recurring transaction will occur within a specified time period of the next occurrence of the recurring financial transaction;
electronically performing the recurring financial transaction at the next occurrence of the recurring financial transaction;
electronically entering a record for the recurring financial transaction at the next occurrence of the recurring financial transaction;
electronically suggesting that the user perform a specified alternative financial transaction instead of performing the recurring financial transaction; and
electronically suggesting that the user perform additional financial transactions based on the classification data obtained from the specified set of users.

5-6. (canceled)

7. The computer-implemented method of claim 1, wherein classification data includes one or more of:
a name of a payee for financial transactions;
a name of a payer for the financial transactions;
a frequency at which financial transactions are repeated; and
a number of users within the specified set of users that has classified the financial transaction as repeating with a given frequency.

8. The computer-implemented method of claim 1, wherein the specified set of users is located within a specified distance of the user.

9. A computer-readable storage medium storing instructions that when executed by a computer cause the computer to perform a method, comprising:
receiving a financial transaction for a user;
determining whether the financial transaction can be classified as a recurring financial transaction from classification data obtained from a specified set of users;
if so,
analyzing the classification data to determine a frequency at which the financial transaction is repeated, by analyzing a number of votes that the classification data classifies the financial transaction using a specified frequency, and determining a specified frequency which has a plurality of votes;
classifying the financial transaction as a recurring financial transaction that is repeated at the determined frequency; and
performing one or more specified actions based on the classification.

10. The computer-readable storage medium of claim 9, wherein after classifying the financial transaction, the method further comprises recording the financial transaction as a recurring financial transaction.

11. The computer-readable storage medium of claim 9, wherein after classifying the financial transaction, the method further comprises suggesting that the financial transaction be recorded as a recurring financial transaction.

12. The computer-readable storage medium of claim 9, wherein the one or more specified actions include one or more of:
reminding the user that the recurring transaction will occur within a specified time period of the next occurrence of the recurring financial transaction;
automatically performing the recurring financial transaction at the next occurrence of the recurring financial transaction;
automatically entering a record for the recurring financial transaction at the next occurrence of the recurring financial transaction;
suggesting that the user perform a specified alternative financial transaction instead of performing the recurring financial transaction; and
suggesting that the user perform additional financial transactions based on the classification data obtained from the specified set of users.

13-14. (canceled)

15. The computer-readable storage medium of claim 9, wherein classification data includes one or more of:
a name of a payee for financial transactions;
a name of a payer for the financial transactions;
a frequency at which financial transactions are repeated; and
a number of users within the specified set of users that has classified the financial transaction as repeating with a given frequency.

16. The computer-readable storage medium of claim 9, wherein the specified set of users is located within a specified distance of the user.

17. A computer-implemented method, comprising:
electronically receiving classification data for financial transactions from a set of users;
electronically aggregating the classification data for the financial transactions; and
electronically distributing the aggregated classification data to users so that the users can classify financial transactions using the aggregated classification data;
wherein a user can classify a financial transaction using the aggregated classification data by:
electronically analyzing the classification data to determine a frequency at which the financial transaction is repeated, by analyzing a number of votes that the classification data classifies the financial transaction using a specified frequency, and determining a specified frequency which has a plurality of votes; and
electronically classifying the financial transaction as a recurring financial transaction that is repeated at the determined frequency.

18. The computer-implemented method of claim 17, wherein aggregating the classification data for the financial transactions involves:
electronically grouping financial transactions that meet specified criteria into a group of financial transactions; and
electronically determining the number of financial transactions that are recurring and that are not recurring.

19. The computer-implemented method of claim 18, wherein determining the number of financial transactions that are recurring and that are not recurring involves:
electronically determining a first set of financial transactions within the group that are not recurring financial transactions;
electronically noting the number of financial transactions that do not recur;
electronically determining a second set of financial transactions within the group that are recurring financial transactions;
electronically determining the frequency at which each financial transaction within the set recurs; and
electronically noting the number of financial transactions that recur at the determined frequencies.

20. The computer-implemented method of claim 18, wherein the specified criteria includes one or more of:
the financial transactions that have the same payer; and
the financial transactions that have the same payee.

21. A computer-readable storage medium storing instructions that when executed by a computer cause the computer to perform a method, wherein the method comprises:
receiving classification data for financial transactions from a set of users;
aggregating the classification data for the financial transactions; and
distributing the aggregated classification data to users so that the users can classify financial transactions using the aggregated classification data;
wherein a user can classify a financial transaction using the aggregated classification data by:
analyzing the classification data to determine a frequency at which the financial transaction is repeated, by analyzing a number of votes that the classification data classifies the financial transaction using a specified frequency, and determining a specified frequency which has a plurality of votes; and
classifying the financial transaction as a recurring financial transaction that is repeated at the determined frequency.

22. The computer-readable storage medium of claim 21, wherein aggregating the classification data for the financial transactions involves:
grouping financial transactions that meet specified criteria into a group of financial transactions; and
determining the number of financial transactions that are recurring and that are not recurring.

23. The computer-readable storage medium of claim 22, wherein determining the number of financial transactions that are recurring and that are not recurring involves:
determining a first set of financial transactions within the group that are not recurring financial transactions;
noting the number of financial transactions that do not recur;
determining a second set of financial transactions within the group that are recurring financial transactions;
determining the frequency at which each financial transaction within the set recurs; and
noting the number of financial transactions that recur at the determined frequencies.

24. The computer-readable storage medium of claim 22, wherein the specified criteria includes one or more of:
the financial transactions that have the same payer; and
the financial transactions that have the same payee.
